(19) United States
(12) Patent Application Publication
(10) Pub. No.: US 2020/0309370 A1
(43) Pub. Date: Oct. 1, 2020

(54) FURNACE FLUE PIPE CLEARANCE DEVICE AND A METHOD OF USING THE SAME

(71) Applicant: Eric Michel Nadeau, Allen Park, MI (US)

(72) Inventor: Eric Michel Nadeau, Allen Park, MI (US)

(21) Appl. No.: 16/364,421

(22) Filed: Mar. 26, 2019

(51) Int. Cl. F23J 3/02; B08B 9/032

(52) U.S. Cl. CPC F23J 3/02; B08B 9/0322

(57) ABSTRACT

A flue pipe clearance device is provided. The flue pipe clearance includes a cap portion dimensioned and adapted to operatively associate with an end of an outbound pipe. The flue pipe clearance device includes an inlet that fluidly communicates to the end of the outbound pipe when the cap portion and outbound pipe are operatively associated. Pressurized gas may be selectively applied to the inlet so as to urge the evacuation of debris or fluids in the outbound pipe through an exhaust end of the outbound pipe.

### BACKGROUND OF THE INVENTION

The present invention relates to furnace flue pipe clearance systems and, more particularly, a furnace flue pipe clearance device and a method of using the same.

Furnaces have flue/exhaust pipes that can become blocked with debris and/or moisture. A brush may be jammed into the pipe to clear a blockage, but not infrequently the brush is not be strong enough to push out debris, or may be too flexible when pushed up against an obstruction in the flue pipe. Moreover, there is no way to effectively and completely remove standing water in the pipe manually by way of brush.

As can be seen, there is a need for a furnace flue pipe clearance device and a method of using the same. The furnace flue pipe clearance device embodied in the present invention provides a cap dimensioned and adapted to operatively associate with the exhaust or outlet end of the flue pipe, so as to form a seal therearound. The furnace flue pipe clearance device also provides an inlet and conduit dimensioned and adapted to fluidly connect a regulated pressure source, such as a pressurized gas tank, to blow out/clear any debris or moisture from the furnace flue pipe, solving the issue of a restricted flue pipe.

The cap may be PVC cap wherein the inlet is a gauge hose attachment, at which point a user can connect to pressurized gas (e.g., CO2 or nitrogen) that selectively urges pressure through the chamber of flue pipe until whatever obstruction, water or debris is blown out by the pressure to the outside. The furnace flue pipe clearance device allows the user to hook up to a 90% furnace PVC flue pipe.

### SUMMARY OF THE INVENTION

In one aspect of the present invention, a flue pipe clearance device, including the following: a cylindrical cap portion providing a sidewall interconnecting a closed end and an open end, wherein the closed end and the sidewall define a cavity the open end communicates with; an inlet provided in the closed end so that the inlet fluidly communicates with the cavity; and the inlet integrated in a protrusion extending away from the cavity.

In another aspect of the present invention, the flue pipe clearance device, including the following: a cylindrical cap portion providing a sidewall interconnecting a closed end and an open end, wherein the closed end and the sidewall define a cavity the open end communicates with; an inlet provided in the closed end so that the inlet fluidly communicates with the cavity; the inlet integrated in a protrusion extending away from the cavity; external threading provided along the protrusion; and one or more gripping texture along an external surface of the sidewall.

In yet another aspect of the present invention, a method of evacuating debris or fluid from a flue pipe of a furnace through the following: providing the above-mentioned flue pipe clearance device, wherein the sidewall is dimensioned to provide an inner diameter generally coextensive with an outer diameter of the flue pipe; disengaging a first end of the flue pipe from an outbound motor of the furnace; engaging the open end to said first end so that the inlet is fluidly communicating with said flue pipe; operatively associating a pressure source to the inlet; and selectively urging pressure through said inlet.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is a section view of an exemplary embodiment of the present invention, taken along line 2-2 in FIG. 1;

FIG. 3 is a schematic view of an exemplary embodiment of the present invention, illustrating a blockage;

FIG. 4 is a schematic view of an exemplary embodiment of the present invention, illustrating a removal of the blockage; and

FIG. 5 is a section view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a flue pipe clearance device includes a cap portion dimensioned and adapted to operatively associate with an end of an outbound pipe. The flue pipe clearance device includes an inlet that fluidly communicates to the end of the outbound pipe when the cap portion and outbound pipe are operatively associated. Pressurized gas may be selectively applied to the inlet so as to urge the evacuation of debris or fluids in the outbound pipe through an exhaust end of the outbound pipe.

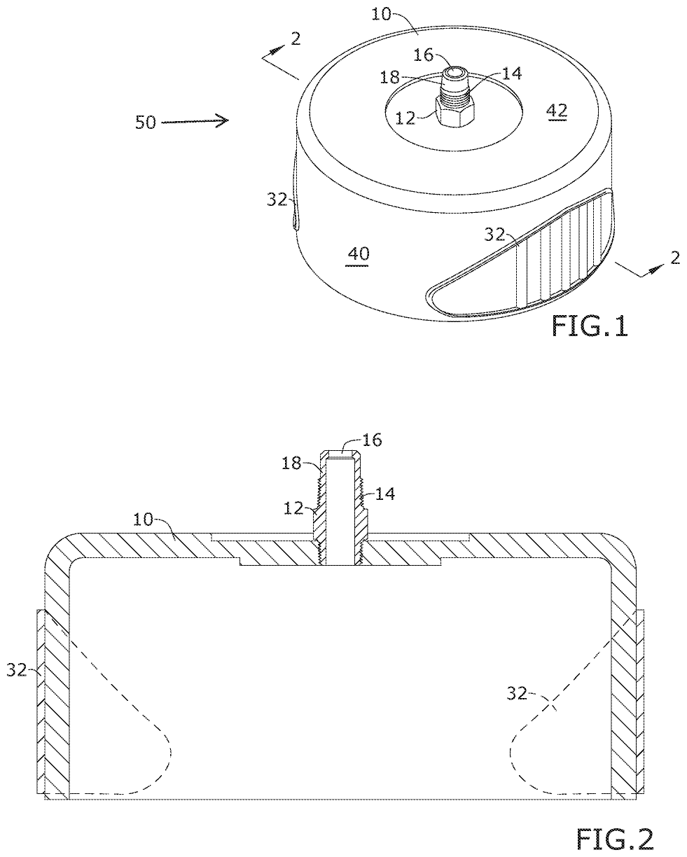

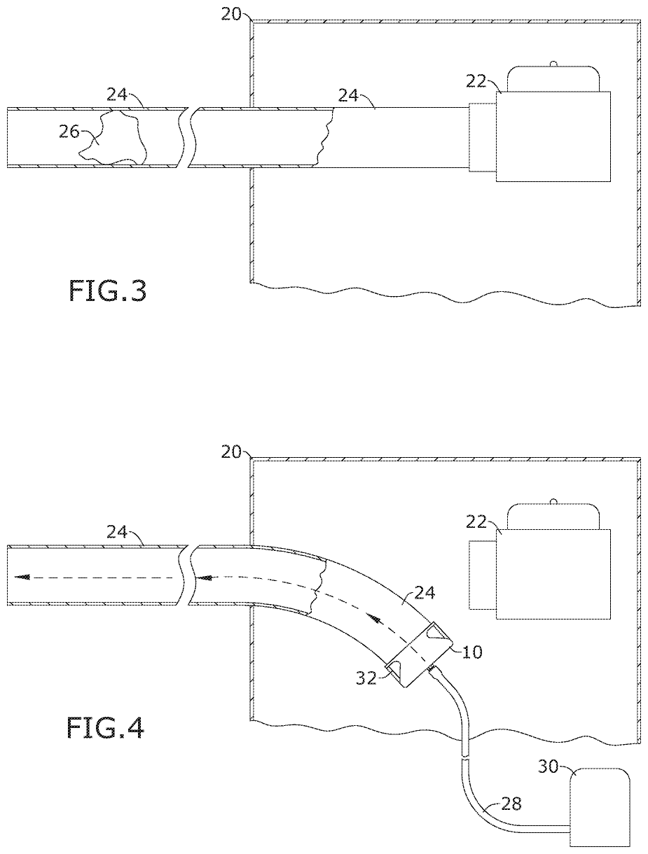

Referring now to FIGS. 1 through 5, the present invention may provide a flue pipe clearance device 50 having a cap portion 10 providing an inlet 16. The cap portion 50 may be a generally hollow cylinder having an open end communicating to a cavity defined by the hollow cylinder providing a sidewall 40 and a closed end 42. In certain embodiments, the cap portion may be a 2-inch or 3-inch PVC cap drilled to provide the inlet 16.

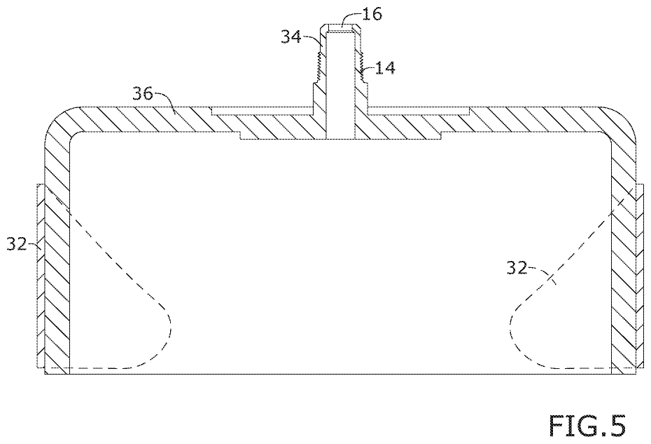

The inlet 16 may be centrally disposed along the closed end 42 so as to communicate with said cavity. The inlet 16 may include a conduit 18 having threading 14 and a fastener 12 for securing the conduit 18 to the closed end 42. In certain embodiments, the conduit 18 may be a 1/4″ refrigeration fitting journaled through the above-mentioned drilled PVC cap. The inlet 16 may include a valve. Referring to FIG. 5, the closed end may have a nozzle unit 34 and closed end 36 that is a unitary structure, wherein the nozzle unit 34 provides the external threading 14 and an internal chamber so that the separate fastener 12 and the separate conduit 18 may not be necessary.

The sidewall 40 is dimensioned and adapted so that they inner surface abuts an outer surface of an end of a pipe 24, or in other words the inner diameter of the sidewall 40 snugly engages an outer diameter of the pipe 24. The exterior surface of the sidewall 40 may provide a gripping texture 32, such as one or more rubber grips to facilitate the engaged condition or disengaging from the engaged condition. In such an engaged condition, as illustrated in FIG. 4, the inlet 16 fluidly communicates with the engaged end of the pipe 24. Such a pipe 24 may be an outbound flue pipe of furnace 20, wherein the outbound flue pipe is operatively associated with the outbound motor 22 of said furnace 20.

A method of using the present invention may include the following. The flue pipe clearance device 50 disclosed above may be provided. A user may provide access to an end of the pipe 24 with a blockage 26, in certain embodiments by disengaging the outbound flue pipe operatively associated with the outbound motor 22. Then the user may slide the sidewalls 40 over said end of the pipe 24 creating a seal between the two. Then the user may fluidly connect the inlet 16 to a tube 28 (such as a compression hose) that in turn is fluidly coupled to a pressure source 30. Upon selectively enabling the pressure source 30 (such as a CO2 or nitrogen gas tank) the applied pressure would dislodge and urge any debris and/or fluid out of the pipe 24 via its exhaust end, as illustrated in FIG. 4.

It should be understood, of course, that the foregoing relates to exemplary embodiments of the invention and that modifications may be made without departing from the spirit and scope of the invention as set forth in the following claims.

What is claimed is:

1. A flue pipe clearance device, comprising:
a cylindrical cap portion providing a sidewall interconnecting a closed end and an open end, wherein the closed end and the sidewall define a cavity the open end communicates with;
an inlet provided in the closed end so that the inlet fluidly communicates with the cavity; and
the inlet integrated in a protrusion extending away from the cavity.

2. The flue pipe clearance device of claim 1, wherein external threading is provided along the protrusion.

3. The flue pipe clearance device of claim 1, wherein the protrusion and the inlet are a unitary structure.

4. The flue pipe clearance device of claim 2, wherein the protrusion, the inlet, and the external threading are a unitary structure.

5. The flue pipe clearance device of claim 1, further comprising one or more gripping texture along an external surface of the sidewall.

6. A flue pipe clearance device, comprising:
a cylindrical cap portion providing a sidewall interconnecting a closed end and an open end, wherein the closed end and the sidewall define a cavity the open end communicates with;
an inlet provided in the closed end so that the inlet fluidly communicates with the cavity;
the inlet integrated in a protrusion extending away from the cavity;
external threading provided along the protrusion; and
one or more gripping texture along an external surface of the sidewall.

7. The flue pipe clearance device of claim 6, wherein the protrusion, the inlet, and the external threading are a unitary structure.

8. A method of evacuating debris or fluid from a flue pipe of a furnace, comprising:
providing the flue pipe clearance device of claim 1, wherein the sidewall is dimensioned to provide an inner diameter generally coextensive with an outer diameter of the flue pipe;
disengaging a first end of the flue pipe from an outbound motor of the furnace;
engaging the open end to said first end so that the inlet is fluidly communicating with said flue pipe;
operatively associating a pressure source to the inlet; and
selectively urging pressure through said inlet.
